(19) United States
(12) Patent Application Publication
(10) Pub. No.: US 2025/0018421 A1
(43) Pub. Date: Jan. 16, 2025

(54) MULTI-LIQUID MIXING AND DISCHARGING TOOL AND HEAD OF MULTI-LIQUID MIXING AND DISCHARGING TOOL

(71) Applicant: TA Co., LTD, Kisarazu-shi (JP)

(72) Inventor: Yukihide Sato, Kisarazu-shi (JP)

(73) Assignee: TA Co., LTD, Kisarazu-shi (JP)

(21) Appl. No.: 18/772,040

(22) Filed: Jul. 12, 2024

(30) Foreign Application Priority Data
Jul. 14, 2023 (JP) 2023-116200

(51) Int. Cl. B05C 17/005; E04G 23/02

(52) U.S. Cl. CPC B05C 17/00553; B05C 17/00506; E04G 23/0211; B05C 17/00516

(57) ABSTRACT

A multi-liquid mixing and discharging tool includes a gripper configured to be held by an operator; a pump installed at the gripper and configured to be driven to independently and alternately pressure-feed a first liquid and a second liquid; a casing detachably attached to an outlet of the pump, and including a first flow path through which the first liquid is pressure-fed from a first outlet of the pump, a second flow path through which the second liquid is pressure-fed from a second outlet of the pump, and a check valve installed at at least one of the first flow path or the second flow path; and a nozzle through which the first liquid and the second liquid flowing in from the casing are mixed and discharged.

### CROSS-REFERENCE TO RELATED APPLICATION

This application claims priority to and benefit of, under 35 USC 119, Japanese Patent Application No. 2023-116200 filed Jul. 14, 2023, the disclosure of which is incorporated by reference herein in its entirety.

### BACKGROUND

### Technical Field

The present disclosure relates to a multi-liquid mixing and discharging tool and a head of the multi-liquid mixing and discharging tool.

### Related Art

For example, a multi-liquid mixing and discharging device disclosed in Japanese Patent Application Laid-Open (JP-A) No. 2021-194613 is configured to mix and discharge at least a first fluid and a second fluid having a density lower than the first fluid, and includes a first flow path for transferring the first fluid, a second flow path for transferring the second fluid, a merging part for mixing the first fluid transferred by the first flow path and the second fluid transferred by the second flow path, and an ingress preventing part for preventing at least one of ingress of the second fluid into the first flow path or ingress of the first fluid into the second flow path.

### SUMMARY

In a case in which a structure, such as a concrete wall, cracks, a mixed liquid that solidifies when mixed can be injected to repair the crack. It is difficult to inject a mixed liquid into a crack of a structure, and the mixed liquid needs to be injected into the crack at high pressure.

However, since two liquids before mixing are to be alternately pressure-fed inside a tool, when the mixed liquid is injected into the crack at high pressure, one liquid flows back to the other liquid side on the upstream side of a casing that is part of the tool, whereby the mixed liquid is generated on the upstream side of the casing and solidifies, and this can damage the tool body.

The disclosure is to prevent damage to a tool body due to a liquid flowing back to the upstream side of a casing and solidifying.

A multi-liquid mixing and discharging tool according to a first aspect includes a gripper configured to be held by an operator, a pump installed at the gripper and configured to be driven to independently and alternately pressure-feed a first liquid and a second liquid, a casing detachably attached to an outlet of the pump, and including a first flow path through which the first liquid is pressure-fed from a first outlet of the pump, a second flow path through which the second liquid is pressure-fed from a second outlet of the pump, and a check valve installed at at least one of the first flow path or the second flow path, and a nozzle through which the first liquid and the second liquid flowing in from the casing are mixed and discharged.

With the multi-liquid mixing and discharging tool according to the first aspect, it is possible to prevent damage to a tool body due to one liquid flowing back to the other liquid side on the upstream side of the casing and solidifying.

A multi-liquid mixing and discharging tool according to a second aspect is the multi-liquid mixing and discharging tool described in the first aspect, in which the check valve is installed at each of the first flow path and the second flow path.

With the multi-liquid mixing and discharging tool according to the second aspect, it is possible to prevent damage to the tool body due to a mixed liquid of the first liquid and the second liquid flowing back to a flow path in which no check valve is installed and solidifying in the entire casing.

A multi-liquid mixing and discharging tool according to a third aspect is the multi-liquid mixing and discharging tool described in any one of the first aspect and the second aspect, in which the casing includes a wall portion formed in an installation region of the check valve and partitioning the first flow path from the second flow path.

With the multi-liquid mixing and discharging tool according to the third aspect, since the respective liquids are present without being mixed in the installation region of the check valve, it is possible to prevent solidification of the mixed liquid in the casing.

A multi-liquid mixing and discharging tool according to a fourth aspect is the multi-liquid mixing and discharging tool described in any one of the first aspect to the third aspect, in which the casing includes a plate having a plate-like shape, supporting the check valve at part of the plate, and allowing the first liquid and the second liquid to flow to the nozzle at another part of the plate.

With the multi-liquid mixing and discharging tool according to the fourth aspect, it is possible to reduce the number of parts, as compared with a configuration in which a part responsible for supporting the check valve and a part responsible for supplying each liquid to the nozzle are independent.

A multi-liquid mixing and discharging tool according to a fifth aspect is the multi-liquid mixing and discharging tool described in any one of the first aspect to the fourth aspect, in which the nozzle is detachably attached to the casing.

With the multi-liquid mixing and discharging tool according to the fifth aspect, it is possible to remove the nozzle from the casing and replace only the nozzle in a case in which solidification occurs only inside the nozzle.

A multi-liquid mixing and discharging tool according to a sixth aspect is the multi-liquid mixing and discharging tool described in any one of the first aspect to the fifth aspect, and includes an elastic body attached to an outer periphery of a tip of the nozzle.

With the multi-liquid mixing and discharging tool according to the sixth aspect, since the elastic body digs into a discharge target when the nozzle is inserted into the discharge target, it is possible to stably discharge the mixed liquid to the discharge target even at high pressure, as compared with a configuration in which the elastic body is not attached to the outer periphery of the tip of the nozzle.

A head of a multi-liquid mixing and discharging tool according to a seventh aspect includes a casing attachable to an outlet of a pump, and including a first flow path through which a first liquid is able to be pressure-fed from a first outlet of the pump, a second flow path through which a second liquid, which is to be solidified by being mixed with the first liquid, is able to be pressure-fed from a second outlet of the pump, a check valve installed at at least one of the first flow path or the second flow path, and a wall portion formed in an installation region of the check valve and partitioning the first flow path from the second flow path, and a nozzle through which the first liquid and the second liquid flowing in from the casing are mixed and discharged.

With the head of the multi-liquid mixing and discharging tool according to the seventh aspect, in a case in which a plurality of liquids to be solidified by mixing is pressure-fed, it is possible to limit a cleaning range of the pump, as compared with a configuration in which the entire pump is cleaned.

The multi-liquid mixing and discharging tool according to the disclosure can prevent damage to the tool body due to a liquid flowing back to the upstream side of the casing and solidifying.

### BRIEF DESCRIPTION OF THE DRAWINGS

Embodiments will be described in detail based on the following figures, wherein:

FIG. 1 is a front view schematically showing a gun according to an embodiment of the present disclosure;

FIG. 2A is a front view in the vicinity of a device-side discharging part to which a packing is assembled in the gun according to the embodiment of the disclosure;

FIG. 2B is a cross-sectional view taken along the line S2-S2 in FIG. 2A;

FIG. 3A is a front view of a socket base of the gun according to the embodiment of the disclosure;

FIG. 3B is a cross-sectional view taken along the line S3-S3 in FIG. 3A;

FIG. 4 is a cross-sectional view of a head according to the embodiment of the disclosure;

FIG. 5 is a cross-sectional view of a nozzle included in the head according to the embodiment of the disclosure;

FIG. 6A is a front view of a valve plug included in the head according to the embodiment of the disclosure;

FIG. 6B is a cross-sectional view taken along the line S6-S6 in FIG. 6A;

FIG. 7A is a front view of a spring stopper of the head according to the embodiment of the disclosure;

FIG. 7B is a right side view of the spring stopper of the head;

FIG. 8A is a cross-sectional view of the valve plug included in the head according to the embodiment of the disclosure with valves incorporated;

FIG. 8B is a cross-sectional view taken along the line S8-S8 in FIG. 8A with one of the valves energized by a first liquid;

FIG. 9A is an upper cross-sectional view with one of the valves closing each of a first flow path and a second flow path; and

FIG. 9B is an upper cross-sectional view with one of the valves of the first flow path opened by the first liquid and the other valve of the second flow path closed.

### DETAILED DESCRIPTION

### Configuration of First Embodiment

With reference to the drawings, a gun 10 as an example of a multi-liquid mixing and discharging tool according to an embodiment of the present disclosure and an example of a head 60 included in the multi-liquid mixing and discharging tool will be described. For convenience of description, an arrow H in the drawings indicates a tool up-down direction (for example, a vertical direction), an arrow W indicates a tool width direction (for example, a horizontal direction), and an arrow D indicates a tool depth direction (for example, a horizontal direction), which are not limited to these directions in actual use of the gun 10.

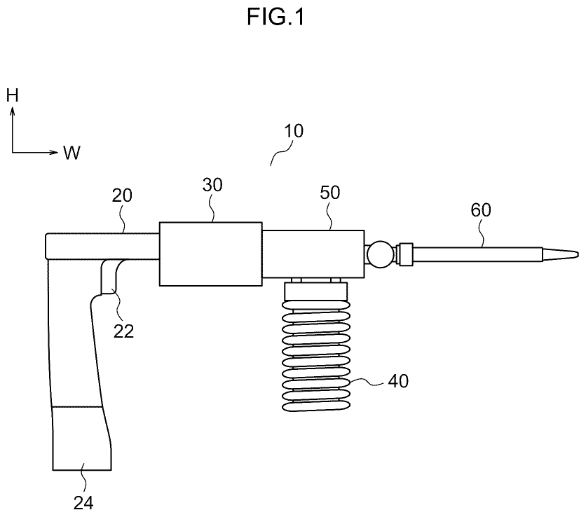

FIG. 1 is a front view schematically showing the gun 10 according to the embodiment of the disclosure. The gun 10 includes a gripper 20, a pump 30, a container 40, a support part 50, and a head 60. When an operator holds the gripper 20 and presses a switch 22, which will be described later, with a tip of the head 60 inserted into a crack, which is a discharge target (not shown), a mixed liquid, which will be described later, is discharged from the head 60. The head 60 of the gun 10 is detachable from the support part 50.

The gun 10 of the present embodiment is an electric gun, for example. The gripper 20 includes a main body 21, a switch 22, and a battery 24. The main body 21 has an L shape, and the battery 24 is installed in a lower part of a portion extending in the up-down direction, and the switch 22 is installed at a position at which the portion extending in the up-down direction and a portion extending in the width direction intersect. The switch 22 is installed so as to protrude from the main body 21. The switch 22 has a movable range in the width direction, and can switch between an ON position in which power is supplied from the battery 24 and an OFF position in which power is not supplied from the battery 24, by operating the switch 22.

The pump 30 is connected to a portion of the gripper 20 extending in the width direction. The pump 30 is a plunger type, for example. When the switch 22 is in the ON position, the pump 30 independently and alternately pressure-feeds a first liquid and a second liquid to the head 60 via the support part 50, which will be described later. When the switch 22 is in the OFF position, the pump 30 does not pressure-feed the first liquid and the second liquid to the head 60. The discharging pressure of the pump 30 is an operation pressure of about 4.9 MPa (that is, 50 kgf/cm²).

The container 40 has a bottomed cylindrical shape extending in the up-down direction, and is installed between the pump 30 and the support part 50, which will be described later. The container 40 has flexibility. A plurality of the containers 40 is installed, and each of which contains the first liquid or the second liquid. Since the gun 10 of the present embodiment discharges a mixed liquid by mixing the first liquid and the second liquid, the first liquid and the second liquid are stored in separate containers 40 before mixing. For example, the first liquid is a main agent of epoxy, the second liquid is a curing agent thereof, and by mixing the first liquid and the second liquid, a mixed liquid, which is a grease-like (that is, gel-like) epoxy resin, is generated in a cylindrical portion 72 of the nozzle 70, which will be described later.

The support part 50 is supported by the gripper 20 via the pump 30, and supports the containers 40, which are interchangeably connected to a lower part in the up-down direction, and the head 60, which is interchangeably connected to the other end in the width direction.

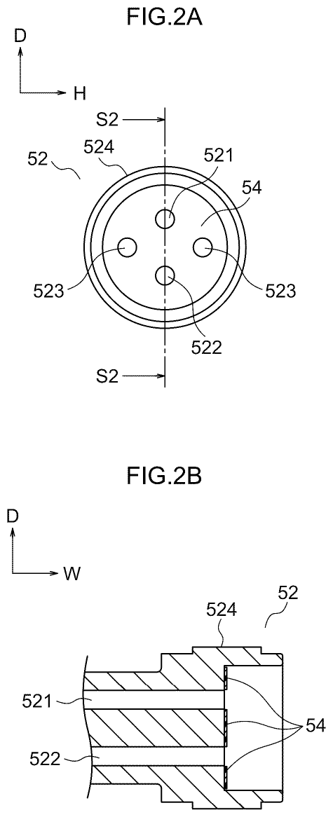

The support part 50 includes a device-side discharging part 52, a packing 54, a socket base 56, and a nut 58 on the head 60 side (that is, the other end side in the width direction). FIG. 2A is a front view in the vicinity of the device-side discharging part 52 to which the packing 54 is assembled in the gun 10 according to the embodiment of the disclosure, and FIG. 2B is a cross-sectional view taken along the line S2-S2 in FIG. 2A.

The device-side discharging part 52 has a columnar shape with a through hole inside, is installed on the other end side in the width direction of the support part 50, and the material there of is SUS (that is, stainless steel) or the like, for example. As shown in FIG. 2B, a first device-side flow path 521, which extends in the width direction and allows the first liquid to flow, and a second device-side flow path 522, which extends in the width direction and is installed in parallel with the first device-side flow path 521 and allows the second liquid to flow, are installed inside the device-side discharging part 52. The downstream end of the first device-side flow path 521 is an example of a first outlet, and the downstream end of the second device-side flow path 522 is an example of a second outlet. Inside the device-side discharging part 52, a pair of screw holes 523 is installed so as to separate each other and sandwich the first device-side flow path 521 and the second device-side flow path 522 in the up-down direction (that is, the H direction) as shown in FIG. 2A. In addition, a male screw portion 524 is installed on the outer surface of the device-side discharging part 52 so as to extend in the width direction (that is, the W direction) as shown in FIG. 2B. The device-side discharging part 52 allows the first liquid and the second liquid to flow to the head 60 side.

The packing 54 is a disk-shaped rubber sheet with a plurality of holes, and the material thereof is chloroprene rubber, for example. The packing 54 is installed so as to be in contact with device-side discharging part 52 from the other end side of the device-side discharging part 52 in the width direction, and prevents liquid leakage between the device-side discharging part 52 and the socket base 56, which will be described later. The packing 54 is installed at a position that does not cover the first device-side flow path 521, the second device-side flow path 522, and the screw holes 523.

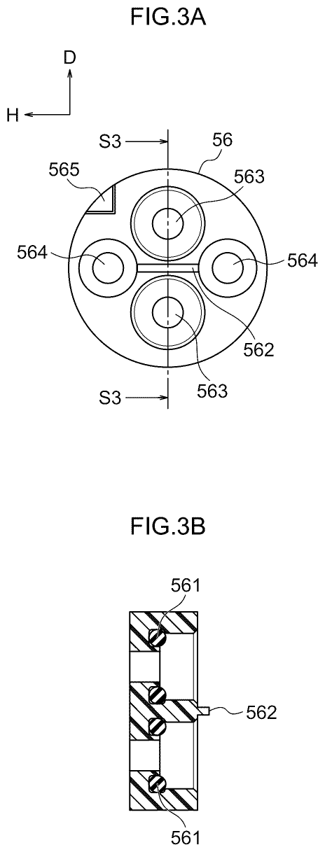

FIG. 3A is a front view of the socket base 56 of the gun 10 according to the embodiment of the disclosure, and FIG. 3B is a cross-sectional view taken along the line S3-S3 in FIG. 3A. As shown in FIG. 3A, the socket base 56 has a disk shape with a plurality of holes, is inserted into the device-side discharging part 52 from the other end side of the device-side discharging part 52, and is in contact with the packing 54 on one surface. The socket base 56 is in contact with the head 60, which will be described later, on the other surface opposite to the one surface in contact with the packing 54. The material of the socket base 56 is PC (that is, polycarbonate) resin or the like, for example.

The socket base 56 is a disk-shaped base material, and includes a seal member 561, a protrusion 562, holes 563, a screw hole 564, and an alignment portion 565. The seal member 561 is an annular elastic body, and is an O-ring, for example. As shown in FIG. 3B, the seal member 561 is installed so as to be interchangeable with respect to the socket base 56, and prevents liquid leakage from the hole 563, which will be described later. The protrusion 562 is a plate-like body installed at the center of the socket base 56 and standing upright from the other surface of the socket base 56, and is used for positioning a valve plug 80 in the head 60. As shown in FIG. 3A, a pair of the holes 563 each having a stepped shape is installed so as to be spaced apart in the depth direction to sandwich the protrusion 562, and each includes a small diameter portion installed on one surface side (that is, the left side of FIG. 3B) and a large diameter portion installed on the other surface side (that is, the right side of FIG. 3B). The holes 563 are installed at positions corresponding to the first device-side flow path 521 and the second device-side flow path 522 of the device-side discharging part 52, and allow the first liquid and the second liquid to flow through the holes 563. The seal member 561 is installed between the small-diameter portion and the large-diameter portion of each hole 563.

As shown in FIG. 3A, a pair of the screw holes 564 is a pair of through holes spaced apart in the width direction (that is, the up-down direction in FIG. 3A) at positions different from the holes 563 so as to sandwich the protrusion 562, and the inner surfaces are not threaded. The screw holes 564 are installed at positions corresponding to the screw holes 523 of the device-side discharging part 52, and screws (not shown) can be inserted in the width direction (that is, from the front side to the back side in FIG. 3A). The screws (not shown) are tightened through the screw hole 564 to the screw holes 523 of the device-side discharging part 52, whereby the device-side discharging part 52, the packing 54, and the socket base 56 are integrated. The distance between the pair of screw holes 564 is longer than the distance between the pair of holes 563.

The alignment portion 565 is a notch installed on the outer periphery of the base material and installed on one surface side from the other surface. The alignment portion 565 is engaged with a protrusion 87 of the valve plug 80, which will be described later, which facilitates alignment of the head 60 with the support part 50 and can prevent the generation of the mixed liquid inside the support part 50 due to assembly errors.

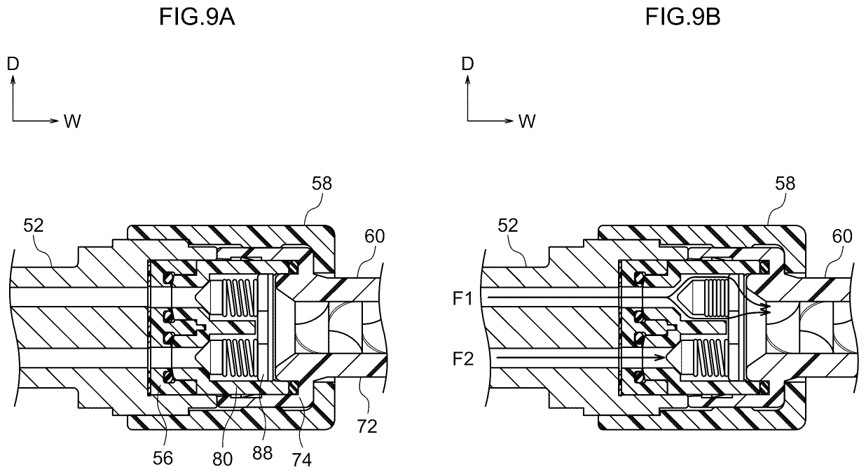

The nut 58 (see FIG. 9A, for example) has a cylindrical shape with a hole in the bottom surface. With the head 60, which will be described later, inserted into the hole in the bottom surface, the male screw portion 524 of the device-side discharging part 52 is tightened to a female screw (not shown) installed on the inner peripheral surface of the nut 58, whereby the head 60 and the support part 50 are integrated. That is, the nut 58 detaches the head 60 from the support part 50 to allow the head 60 to be interchangeable.

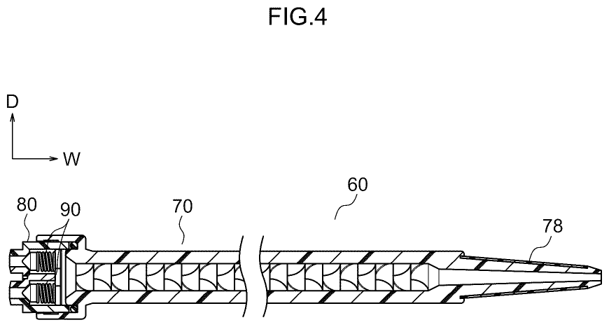

FIG. 4 is a cross-sectional view of the head 60 according to the embodiment of the disclosure. The head 60 includes a nozzle 70, a valve plug 80 as an example of a casing, and a valve 90 as an example of a check valve. The head 60 mixes the first liquid and the second liquid pressure-fed by the pump 30 from the gripper 20 side of the gun 10, and discharges the mixed liquid from the tip.

### Nozzle 70

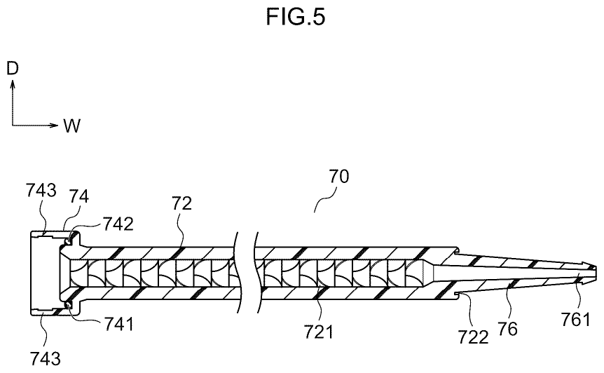

FIG. 5 is a cross-sectional view of the nozzle 70 included in the head 60 according to the embodiment of the disclosure. The nozzle 70 has a cylindrical shape and a function of mixing the first liquid and the second liquid therein. The nozzle 70 includes a cylindrical portion 72, a housing 74, a tip portion 76, and a cover 78 as an example of an elastic body as shown in FIG. 4.

The cylindrical portion 72 includes a twisted portion 721 and a recessed portion 722, and has a cylindrical shape extending in the width direction of the gun 10. The cylindrical portion 72 mixes the first liquid and the second liquid. The material of the cylindrical portion 72 is, for example, PC (that is, polycarbonate) resin or the like, or PET (that is, polyethylene terephthalate) resin or the like. In one section inside the cylindrical portion 72, the twisted portion 721 is installed. The twisted portion 721 may be formed in any known method. For example, the twisted portion 721 has a shape twisted at a predetermined angle and direction for each predetermined distance. The twisted portion 721 is inserted into the cylindrical portion 72 from the housing 74 side. The recessed portion 722 is a groove formed in an end portion of the cylindrical portion 72 and opened to the tip portion 76 side, which will be described later, and has a function of positioning the cover 78.

The housing 74 is a bottomed cylindrical base body with a hole in the bottom surface, and is formed continuously with the cylindrical portion 72. The housing 74 includes, in the base body, a seal member 741, a seat portion 742, and a groove portion 743. The seal member 741 is an elastic body formed in an annular shape, is installed so as to be interchangeable with respect to a base body 740, and prevents liquid leakage from the inside to the outside of the base body in a state of the nozzle 70, which will be described later. For example, the seal member 741 is an O-ring. The seat portion 742 is installed on the outer peripheral side of the cylindrical portion 72 and functions as a seat surface of the seal member 741. The groove portion 743 is a pair of facing grooves installed on the inner peripheral surface of the base body, and is formed in a direction away from the cylindrical portion 72 in the width direction from the end portion of the cylindrical portion 72. The groove portions 743 are engaged with the valve plug 80, which will be described later, whereby the nozzle 70 and the valve plug 80 are integrated. That is, the nozzle 70 is detachably attached to the valve plug 80.

The tip portion 76 is a conical body with a through hole 761 in the center portion and a recess in the outer peripheral surface, internally communicates with the cylindrical portion 72, and is formed on the opposite side of the housing 74 across the cylindrical portion 72. The tip portion 76 is inserted into a discharge target (not shown) in order to discharge the mixed liquid. The through hole 761 is a hole passing through from the end portion on the cylindrical portion 72 side to the tip, and the mixed liquid in which the first liquid and the second liquid are mixed is pressure-fed into the through hole. The recess of the outer peripheral surface of the tip portion 76 extends over the outer peripheral surface. Regarding the inner diameter of the tip portion 76, the inner diameter of the end portion on the cylindrical portion 72 side is formed so as to be equal to or thinner than the inner diameter of the end portion of the cylindrical portion 72, and the inner diameter gradually decreases from the end portion on the cylindrical portion 72 side toward the tip.

As shown in FIG. 4, the cover 78 is a cylindrical body, and is an elastic body attached to the outer periphery of the tip portion 76. For example, the material of the cover 78 is a thermoplastic elastomer or the like. The length of the cover 78 from one end to the other end (that is, the length in the width direction in FIG. 4) is shorter than the length of the tip portion 76 in the width direction. That is, with the one end of the cover 78 inserted into the recessed portion 722 of the cylindrical portion 72, the tip of the tip portion 76 protrudes from the other end of the cover 78. When the gun 10 with the cover 78 attached to the outer periphery of the tip portion 76 is inserted into a discharge target, the movement of the cover 78 in the width direction is restricted by the recessed portion 722, and the cover 78 itself is elastically deformed in the width direction, whereby the cover 78 digs into the discharge target.

### Valve Plug 80

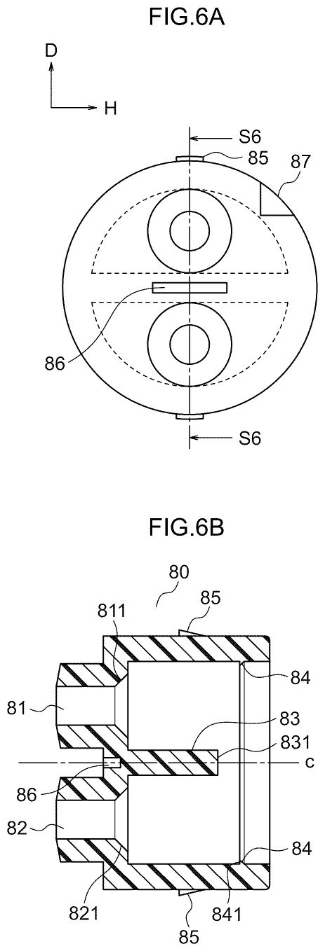

FIG. 6A is a front view of the valve plug 80 included in the head 60 according to the embodiment of the disclosure, and FIG. 6B is a cross-sectional view taken along the line S6-S6 in FIG. 6A. As shown in FIG. 6B, the valve plug 80 is a cylindrical body extending in the width direction, and the inside thereof is partitioned in order to prevent mixing of the first liquid and the second liquid. The valve plug 80 connects the socket base 56 of the support part 50 and the nozzle 70. The valve plug 80 includes, in the cylindrical body, a first flow path 81, a second flow path 82, a wall 83 as an example of a wall portion, an inner claw portion 84, an outer claw portion 85, a groove 86, a protrusion 87, and a spring stopper 88 as an example of a plate. The material of the valve plug 80 is PP (that is, polypropylene) resin, for example.

The first flow path 81 is a flow path for the first liquid installed inside the bottomed cylindrical body with the upstream side as the bottom, and guides the first liquid pressure-fed from the first device-side flow path 521 on the upstream (the pump 30) side to the downstream side (that is, the nozzle 70). The second flow path 82 is a flow path for the second liquid installed inside the bottomed cylindrical body, and guides the second liquid pressure-fed from the second device-side flow path 522 on the upstream (the pump 30) side to the downstream side (that is, the nozzle 70).

The first flow path 81 and the second flow path 82 are formed by separate and independent pipes protruding from the bottom of the cylindrical body to the upstream side, and these pipes are disposed at positions corresponding to the pair of holes 563 of the socket base 56. As shown in FIGS. 6A and 6B, the first flow path 81 and the second flow path 82 are, inside the cylindrical body, independent flow paths each formed in a semi-cylindrical shape and sharing the wall 83, and this can be said that the cylindrical body is partitioned into the first flow path 81 and the second flow path 82 by the wall 83. In other words, each of the first flow path 81 and the second flow path 82 has a shape connecting the pipe and the semi-cylindrical body, and downstream portions of the first flow path 81 and the second flow path 82 form an installation region of the valve 90, which will be described later, inside the cylindrical body. The wall 83 is a plate-like body formed inside the cylindrical body, extends from an end opposite to the end on the nozzle 70 side toward the end on the nozzle 70 side, and partitions the first flow path 81 from the second flow path 82 in the depth direction. The wall 83 is formed closer to the end on the socket base 56 side than to the end on the nozzle 70 side of the cylindrical body, and a face 831 is formed at the end on the nozzle 70 side.

The first flow path 81 and the second flow path 82 have tapered portions 811 and 821, respectively, on the upstream side of the wall 83. The flow path diameters of the first flow path 81 and the second flow path are formed larger on the downstream side of the tapered portions 811 and 821 than on the upstream side of the tapered portions 811 and 821.

The inner claw portion 84 is formed in a claw shape standing upright toward the center C of the cylindrical body over the inner peripheral surface of the cylindrical body. The inner claw portion 84 includes a face portion 841 facing the face 831 of the wall 83 and supports the spring stopper 88, which will be described later.

The outer claw portion 85 is formed in a claw shape standing upright along the depth direction on the outer periphery of the cylindrical body. The height of the outer claw portion 85 decreases from the upstream side toward the downstream side of the first flow path 81 and the second flow path 82. The outer claw portion 85 can be engaged with the groove portion 743 of the housing 74 in the nozzle 70.

The groove 86 is formed on an outer surface of the cylindrical body and between the first flow path 81 and the second flow path 82, and is opened in a direction opposite to the direction in which the wall 83 extends (for example, in the width direction). The groove 86 can accommodate the protrusion 562 of the socket base 56 in the support part 50, and the valve plug 80 and the support part 50 are positioned by the groove 86 accommodating the protrusion 562.

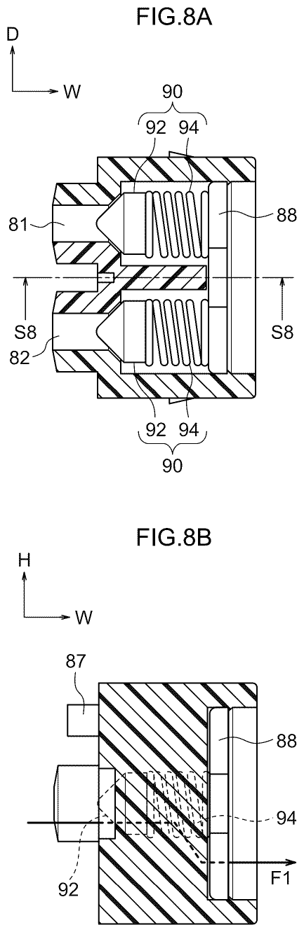

As shown in FIGS. 6A and 8B, the protrusion 87 stands upright on an outer surface of the cylindrical body and in the direction opposite to the direction in which the wall 83 extends (for example, in the width direction). The protrusion 87 is engaged with the alignment portion 565 of the socket base 56 in the support part 50, whereby the valve plug 80 and the support part 50 are positioned. The groove 86 positions the valve plug 80 and the support part 50 even when the phase is reversed 180°, whereas the protrusion 87 uniquely positions the valve plug 80 and the support part 50.

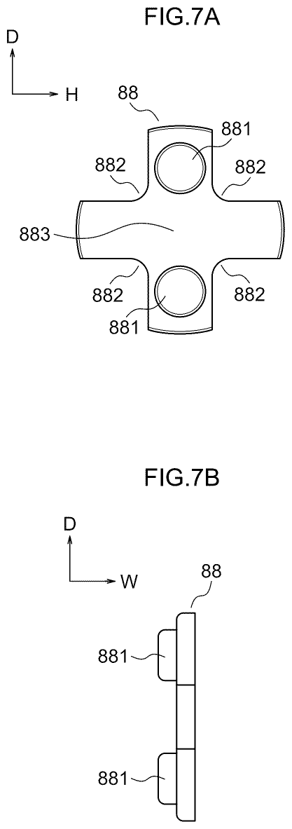

FIG. 7A is a front view of the spring stopper 88 of the head 60 according to the embodiment of the disclosure, and FIG. 7B is a right side view thereof. As shown in FIG. 7A, the spring stopper 88 is a cross-shaped plate, and the spring stopper 88 includes, in the cross-shaped plate-like body, a protruding portion 881, a notch 882, and a central portion 883, and is detachably assembled to the inside of the valve plug 80. As shown in FIG. 7B, one surface (that is, the right side surface in the width direction) of the cross-shaped body is flat and abuts on the face portion 841 of the inner claw portion 84. As a result, the spring stopper 88 supports the valve 90, which will be described later. That is, the spring stopper 88 supports the valve 90 at part thereof (that is, the protruding portion 881, which will be described later).

The protruding portion 881 is a disk-shaped protrusion, and two of the protruding portions 881 are formed apart from each other in the depth direction of the cross-shaped body. The protruding portions 881 are formed at positions facing the first flow path 81 and the second flow path 82.

As shown in FIG. 7A, the notch 882 is four regions installed apart from each other on the outer peripheral surface of the cross-shaped body. The notch 882 forms a space between the inner peripheral surface of the valve plug 80 and the outer peripheral surface of the spring stopper 88 while being incorporated in the valve plug 80. The space forms part of the first flow path 81 and the second flow path 82.

As shown in FIG. 7B, the central portion 883 is a flat portion formed on the other surface (that is, the surface on the left side in the width direction), and is positioned between the two protruding portions 881. The central portion 883 abuts on the face 831 of the wall 83. The central portion 883 abuts on the face 831, whereby the first flow path 81 and the second flow path 82 are partitioned as independent flow paths from the other surface to the one surface of the central portion 883. That is, similar to the wall 83, the spring stopper 88 partitions the first flow path 81 from the second flow path 82 to allow the first liquid flowing through the first flow path 81 and the second liquid flowing through the second flow path 82 to flow to the nozzle 70 at the other part of the spring stopper 88.

### Valve 90

The valve 90 is described below. The valve 90 prevents backflow of the first liquid and the second liquid flowing through the first flow path 81 and the second flow path 82, respectively. FIG. 8A is a cross-sectional view of the valve plug 80 included in the head according to the embodiment of the disclosure with a plurality of the valves 90 incorporated, and FIG. 8B is a cross-sectional view taken along the line S8-S8 in FIG. 8A with the valve 90 is energized by the first liquid.

As shown in FIG. 8A, Each of the valves 90 includes a valve body 92 and a spring 94. Part of the valve body 92 on the upstream side is formed in a conical shape, the maximum outer diameter of the valve body 92 is formed so as to be larger than the diameter of the pipe portion of each of the first flow path 81 and the second flow path 82, and the valve body 92 is formed so as to be smaller than the space of the semicircular portion of each of the first flow path 81 and the second flow path 82. One end of the valve body 92 abuts on each of the tapered portion 811 of the first flow path 81 as a valve seat and the tapered portion 821 of the second flow path 82 as a valve seat to close each of the first flow path 81 and the second flow path 82. The other end of the valve body 92 is supported by the spring 94.

The spring 94 is a compression coil spring, and has one end supporting the valve body 92 and the other end supported by the spring stopper 88 of the valve plug 80. The spring 94 is accommodated in the valve plug 80 in a compressed state greater than the natural length. That is, when the first liquid and the second liquid are not pressure-fed from the first flow path 81 and the second flow path 82, the spring 94 bring the valve body 92 into contact with each of the tapered portions 811 and 821, and when the first liquid and the second liquid are pressure-fed, the spring 94 is further compressed together with the valve body 92 by hydraulic pressure. The spring 94 is supported by being wound around the outer periphery of the spring stopper 88.

The gun 10 and the head 60 are configured as described above.

### Effects

FIG. 9A is an upper cross-sectional view with the valve 90 closing each of the first flow path 81 and the second flow path 82, and FIG. 9B is an upper cross-sectional view with the valve of the first flow path opened by the first liquid and the valve of the second flow path closed.

First, when an operator simply holds the gun 10 and presses the tip portion 76 of the nozzle 70 against a discharge target, the first liquid and the second liquid are not pressure-fed from the containers 40, and the state in FIG. 9A is maintained inside the gun 10. The switch 22 of the gun 10 is maintained in the OFF position.

Next, when the operator moves the switch 22 of the gun 10 to the ON position, electric power is supplied from the battery 24, and the pump 30 is driven. When the pump 30 is driven, the first liquid and the second liquid are alternately sucked up from the containers 40, and alternately flow through the first flow path 81 and the second flow path 82 to press the valve body 92 of the valve 90.

When the hydraulic pressure of at least one of the first liquid or the second liquid exceeds a specified load of the spring 94, the spring 94 is further compressed, and the valve body 92 is separated from the tapered portion 811 or 821, which causes the spring 94 to open. In the flow path in which the spring 94 is opened is positioned, the first liquid or the second liquid flows into the valve plug 80, passes through the spring stopper 88 on the downstream side of the valve 90, and reaches the cylindrical portion 72 of the nozzle 70. The example shown in FIG. 9B shows that a first liquid F1 opens the valve 90 and a second liquid F2 does not open the valve 90. Since the pump 30 alternately and independently pressure-feeds the first liquid F1 and the second liquid F2 to the head 60, the second liquid F2 opens the valve 90 and the first liquid F1 does not open the valve 90 at the next timing.

When the first liquid and the second liquid independently and alternately pressure-fed in this manner merge at the twisted portion 721 of the cylindrical portion 72, the mixed liquid in which the first liquid and the second liquid are mixed is injected from the tip portion 76 into the discharge target.

When the operator moves the switch 22 of the gun 10 to the OFF position after the mixed liquid is injected into the discharge target, at least the mixed liquid in which the first liquid and the second liquid are mixed is present inside the head 60. Since the mixed liquid has curability, curing proceeds inside the nozzle 70 when the mixed liquid is left, and the nozzle 70 is eventually solidified. When the nozzle 70 is solidified, even if the operator moves the switch 22 of the gun 10 to the ON position again, a new mixed liquid is not supplied to the nozzle 70.

In the gun 10 and the head 60 according to the present embodiment, the valve plug 80 includes the valve 90, and it is possible to prevent damage to the main body of the gun 10 due to the mixed liquid flowing back to the upstream side of the valve plug 80 and solidifying.

Subsequently, the valve 90 is installed at each of the first flow path 81 and the second flow path 82. According to the above configuration, it is possible to prevent damage to the main body of the gun 10 due to the mixed liquid of the first liquid and the second liquid flowing back to a flow path in which the valve 90 is not installed and the entire valve plug 80 solidifying.

Subsequently, the valve plug 80 is formed in the installation region of the valve 90 and includes the wall 83 that partitions the first flow path 81 from the second flow path 82. According to the above configuration, since the respective liquids are present without mixing in the installation region of the valve 90, it is possible to prevent solidification of the mixed liquid in the valve plug 80.

Subsequently, the valve plug 80 includes the spring stopper 88 having the above-described configuration. According to the configuration, it is possible to reduce the number of parts, as compared with a configuration in which a part responsible for supporting the valve 90 and a part responsible for supplying each liquid to the nozzle 70 are independent.

Subsequently, the nozzle 70 of the gun 10 is detachably attached to the valve plug 80 having the above-described configuration. According to the configuration, it is possible to remove the valve plug 80 from the nozzle 70 and replace only the nozzle 70 in a case in which solidification occurs only inside the nozzle 70.

The gun 10 includes the cover 78 having the above-described configuration. According to the configuration, since the cover 78 digs into a discharge target when the nozzle 70 is inserted into the discharge target, it is possible to stably discharge the mixed liquid to the discharge target even at high pressure, as compared with a configuration in which a cover is not attached to the outer periphery of the tip of the nozzle 70.

Furthermore, the head 60 used for the gun 10 includes the valve plug 80 attachable to an outlet of the pump 30 and including the first flow path 81 through which the first liquid can be pressure-fed from the first device-side flow path 521 of the pump 30, the second flow path 82 through which the second liquid, which is to be solidified by being mixed with the first liquid, can be pressure-fed from the second device-side flow path 522 of the pump 30, the valve 90 installed in at least one of the first flow path 81 or the second flow path 82, and the wall 83 formed in an installation region of the valve 90 and partitioning the first flow path 81 from the second flow path 82, and the nozzle 70 through which the first liquid and the second liquid flowing in from the valve plug 80 are mixed and discharged.

According to the above configuration, in a case in which a plurality of liquids to be solidified by mixing is pressure-fed, it is possible to limit a cleaning range of the pump 30, as compared with a configuration in which the entire pump 30 is cleaned.

### Modified Example

The disclosure has been described in detail with respect to specific embodiments, but the disclosure is not limited to such embodiments, and it is apparent to those skilled in the art that the disclosure can take various other embodiments within the scope of the disclosure.

Although materials are described in some configurations of the present embodiment, materials different from these materials may be used. For example, the resin portion may be substituted for metal.

The battery 24 is installed in a lower part of the gripper 20, but is not limited thereto. For example, the battery 24 may be built in the gripper 20, or power may be supplied from an external power supply via a power cord.

The pump 30 is an electric pump, but is not limited thereto. For example, a hydraulic type, a pneumatic type, or the like may be used.

The container 40 may be a plurality of containers depending on the number of liquids, or one container may be divided by partitions. The container 40 has flexibility, but is not limited thereto.

The support part 50 includes the independent device-side discharging part 52 and socket base 56, but is not limited thereto. For example, the device-side discharging part 52 may independently have the function of the socket base 56. In this case, a reduction in the number of parts and weight can be expected. The nut 58 in the support part 50 fixes the support part 50 and the head 60, but is not limited thereto. For example, the support part 50 and the head 60 may be installed with an engaging portion and an engaged portion, respectively, and the engaging portion and the engaged portion may be directly engaged. In this case, a reduction in the number of parts and weight can be expected.

The shape of the cover 78 is not limited to the shape in which the cylindrical body is attached to the outer periphery of the tip portion 76. For example, a block-shaped body with a through hole therein may be attached to the outer periphery of the tip portion 76.

The spring stopper 88 is a cross-shaped plate, but is not limited thereto. For example, the spring stopper 88 may have a polygonal shape such as a star shape.

In addition, a compression coil spring is used for the valve 90, but is not limited thereto. Other springs may be used as long as the springs are configured to energize a liquid from the downstream side where the liquid flows to the upstream side. The valve 90 is supported by the valve body 92, but is not limited thereto. For example, the valve 90 may be supported by the inner wall of the valve plug 80.

What is claimed is:

1. A multi-liquid mixing and discharging tool comprising:
a gripper configured to be held by an operator;
a pump installed at the gripper and configured to be driven to independently and alternately pressure-feed a first liquid and a second liquid;
a casing detachably attached to an outlet of the pump, and including a first flow path through which the first liquid is pressure-fed from a first outlet of the pump, a second flow path through which the second liquid is pressure-fed from a second outlet of the pump, and a check valve installed at at least one of the first flow path or the second flow path; and
a nozzle through which the first liquid and the second liquid flowing in from the casing are mixed and discharged.

2. The multi-liquid mixing and discharging tool according to claim 1, wherein
the check valve is installed at each of the first flow path and the second flow path.

3. The multi-liquid mixing and discharging tool according to claim 2, further comprising
an elastic body attached to an outer periphery of a tip of the nozzle.

4. The multi-liquid mixing and discharging tool according to claim 1, wherein
the casing includes a wall portion formed in an installation region of the check valve and partitioning the first flow path from the second flow path.

5. The multi-liquid mixing and discharging tool according to claim 4, further comprising
an elastic body attached to an outer periphery of a tip of the nozzle.

6. The multi-liquid mixing and discharging tool according to claim 1, wherein
the casing includes a plate having a plate-like shape, supporting the check valve at part of the plate, and allowing the first liquid and the second liquid to flow to the nozzle at another part of the plate.

7. The multi-liquid mixing and discharging tool according to claim 6, further comprising an elastic body attached to an outer periphery of a tip of the nozzle.

8. The multi-liquid mixing and discharging tool according to claim 1, wherein the nozzle is detachably attached to the casing.

9. The multi-liquid mixing and discharging tool according to claim 8, further comprising
an elastic body attached to an outer periphery of a tip of the nozzle.

10. The multi-liquid mixing and discharging tool according to claim 1, further comprising
an elastic body attached to an outer periphery of a tip of the nozzle.

11. A head of a multi-liquid mixing and discharging tool, the head comprising:
a casing attachable to an outlet of a pump of a multi-liquid mixing and discharging tool, and including a first flow path through which a first liquid is able to be pressure-fed from a first outlet of the pump, a second flow path through which a second liquid, which is to be solidified by being mixed with the first liquid, is able to be pressure-fed from a second outlet of the pump, a check valve installed at at least one of the first flow path or the second flow path, and a wall portion formed in an installation region of the check valve and partitioning the first flow path from the second flow path; and
a nozzle through which the first liquid and the second liquid flowing in from the casing are mixed and discharged.
